(19) United States
(12) Patent Application Publication
(10) Pub. No.: US 2025/0303307 A1
(43) Pub. Date: Oct. 2, 2025

(54) VALUATION SYSTEM OF GAME EVENTS AND VALUATION METHOD PERFORMED THEREBY

(71) Applicant: Cloud Latitude Co., Ltd., Taichung (TW)

(72) Inventors: Hsien-Cheng WU, Taichung (TW); Wei CHEN, Taichung (TW)

(21) Appl. No.: 18/624,321

(22) Filed: Apr. 2, 2024

(51) Int. Cl. A63F 13/828; A63F 13/35; A63F 13/798

(52) U.S. Cl. CPC A63F 13/828; A63F 13/35; A63F 13/798

(57) ABSTRACT

The present invention is a valuation system of game events and a valuation method performed thereby, and in order to provide a contest game for a plurality of players to play, the valuation system includes a data storage unit, an item selection unit, a plurality of user units, a data calculation unit and a central processing unit; and a program of the valuation method includes a creating contest program, a joining contest program, a creating rating item program, a selecting member program, a waiting contest program, an acquiring data program, and a calculating ranking program.

### FIELD OF THE INVENTION

The present disclosure relates to a gaming system and method, and more particularly to a valuation system of game events and a valuation method performed thereby.

### BACKGROUND OF THE INVENTION

Fantasy Sports game is a new game for people to participate in sports contests, which is an on-line game combining sports knowledge and strategy. Referring to FIG. 1, in the conventional Fantasy Sports game, a game operation process includes a contest member selection program P1, a program P2 for determining whether the selection is terminated, a match result acquisition program P3, a statistical score program P4 and a user ranking list generation program P5. The Fantasy Sports game may select a sports event, such as a basketball, baseball, soccer, etc. to be played by a real entity as a game target. The contest time of the Fantasy Sports game can be one sports event or one season of sports events (consisting of multiple sports events). The Fantasy Sports game can provide all contest members that can participate in the sports event as a selection option, and in the contest member selection program P1, the player can select at least one contest member as a contest group for the Fantasy Sports game following his/her judgment or preference and according to a setting of the Fantasy Sports game.

Next, the Fantasy Sports game performs the program P2 for determining whether the selection is terminated. The Fantasy Sports game sets a termination time before starting the sports event, after which the player cannot change the contest member selected for the contest group. The Fantasy Sports game continues to determine whether the termination time has been reached in the program P2 for determining whether the selection is terminated. If the termination time has not been reached, the player can freely choose to change the contest member for the contest group. If the termination time has been reached, the player is prohibited from changing the contest member for the contest group.

Then, the Fantasy Sports game proceeds to the match result acquisition program P3, contest data of the sports event is acquired after the result is generated for the sports event, the contest data is sports event results of all the contest members in various scoring items in the sports event.

Next, the Fantasy Sports game proceeds to the statistical score program P4 to calculate a statistical score for each player's contest group based on the player's contest group and the contest data of the sports event. In more detail, each of the all contest members acquires a contest score according to the contest data, and the statistical score of the contest group can be known as long as the contest scores of all the contest members in the contest group are counted.

Finally, the Fantasy Sports game proceeds to a user ranking list generation program P5 to generate a ranking list for ranking according to the statistical score of the contest group, and the player can acquire a specific prize according to a ranking on the ranking list.

In the Fantasy Sports game as described above, the contest members acquire the contest score according to the contest data, and in more detail, the Fantasy Sports game may develop a standard of valuation all the scoring items in the contest data. Taking basketball as an example, various scoring items in the contest data, such as scoring, shooting percentage, free throw percentage, three-point shooting percentage, rebounding, assists, steals, and blocks, etc. may be included in the valuation items.

In the Fantasy Sports game, some restrictions are also set in the contest member selection program P1. For example, the contest members may be marked with their character positions assumed in the sports event, such as a small forward, a power forward, a center forward, and a rear guard in basketball, and the selectable number of individual character positions in the contest group is restricted so that the contest members of different character positions may be spotted by the players.

However, since all the scoring items are included for valuation, which results in the contest member having an all-round performance being a popular choice for the contest group, the selections of different players may not be different, and for a long time, the playing method of the Fantasy Sports game may be over-styled, and the ability to attract players may be lost, and there is room for improvement.

### SUMMARY OF THE INVENTION

A main object of the invention is to disclose a valuation system of game events and a valuation method, which can attract players to play by increasing changes of the game through changing contest ranking items.

In order to achieve the above object, the invention provides a valuation system of game events in order to provide a contest game for a plurality of players to play, and the valuation system of game events includes a data storage unit, an item selection unit, a plurality of user units, a data calculation unit, and a central processing unit, wherein the data storage unit acquires contest data of a substantial contest to be performed and contest data of the substantial contest after the substantial contest ends, the contest data containing a plurality of contest members participated in the substantial contest, the contest data including a plurality of item data of the plurality of contest members in a plurality of scoring items respectively. The item selection unit selects a specific quantity of the scoring items as a contest rating and ranking item of the contest game. The plurality of user units are respectively provided for the plurality of players to play and operate the contest game, and are respectively provided for registering, logging in, modifying and storing member data, and the plurality of user units are respectively provided for the plurality of players to create a contest member list before the substantial contest is performed, and the contest member list is generated by selecting at least one from a plurality of contest members. The data calculation unit calculates each of the plurality of item data of the contest ranking item according to a calculation rule, so as to obtain a valuation score, and the data calculation unit counts valuation scores of all contest members in each contest member list on the contest ranking item after the substantial contest ends, thereby generating a total score of all contest members in each contest member list, and ranks according to a magnitude of the total score to generate a contest ranking. The central processing unit links and processes operations of the data storage unit, the item selection unit, the plurality of user units and the data calculation unit and performs transmission and exchange of the contest information, the contest data, the contest ranking item, the valuation score, the member data, the contest member list and the contest ranking, and the central processing unit is set to execute programs as follows: acquiring the contest information and creating the contest game; waiting for the plurality of players to join the contest game; waiting for the item selection unit to create the contest ranking item; waiting for the plurality of players to create the contest member list; waiting for the substantial contest to start until ending; acquiring the contest data; and acquiring the contest ranking through the data calculation unit.

The present disclosure also discloses a valuation method of the valuation system, wherein a program of the valuation method includes a creating contest program S1, a joining contest program S2, a creating rating item program S3, a selecting member program S4, a waiting contest program S5, an acquiring data program S6 and a calculating ranking program S7. In the creating contest program S1, the central processing unit acquires the contest information of the substantial contest through the data storage unit so as to create the contest game. In the joining contest program S2, the central processing unit waits for the plurality of players to choose to join the contest game through the plurality of user units for playing. In the creating rating item program S3, the central processing unit waits for the item selection unit to select a specific quantity of the plurality of scoring items as the contest ranking item. In the member selection program S4, the central processing unit provides a selection time for the plurality of players to create the contest member list through the plurality of user units before the substantial contest starts. In the waiting-during-contest program S5, the central processing unit waits for the substantial contest to start until ending. In the data acquisition program S6, the central processing unit acquires the contest data through the data storage unit after the substantial contest ends. In the ranking calculation program S7, the central processing unit firstly obtains the valuation score through the data calculation unit and then generates the total score through the data calculation unit and acquires the contest ranking.

In view of the foregoing content, in the contest game provided by the present invention, the plurality of scoring items of the contest ranking item is established through the item selection unit, so that the scoring items of the contest ranking item can be changed, the variability of the contest game can be increased, and the contest game can maintain the ability to attract players.

### BRIEF DESCRIPTION OF THE DRAWINGS

FIG. 1 is a flow chart illustrating the operation of a conventional game.

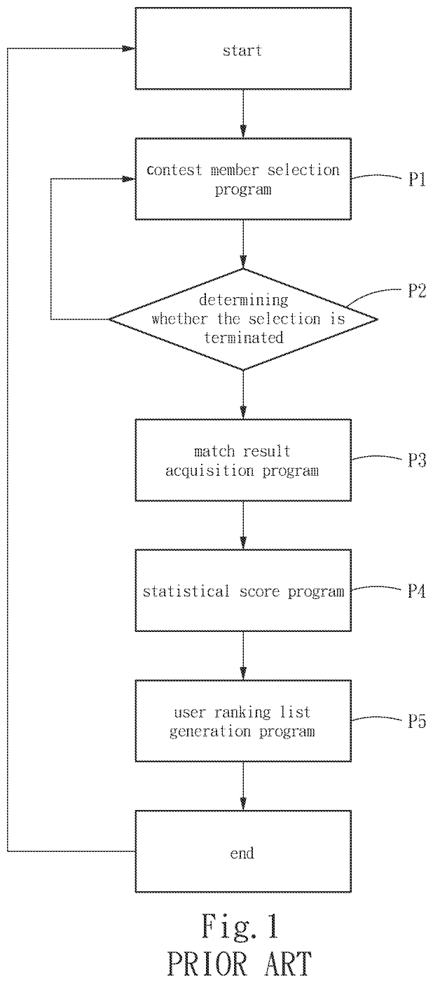

FIG. 2 is an architecture diagram of a gaming system of the present disclosure.

FIG. 3 is a flow chart illustrating an operation of the present disclosure.

### DETAILED DESCRIPTION OF THE PREFERRED EMBODIMENTS

The detailed description and technical content of the invention are described below with reference to the accompanying drawings.

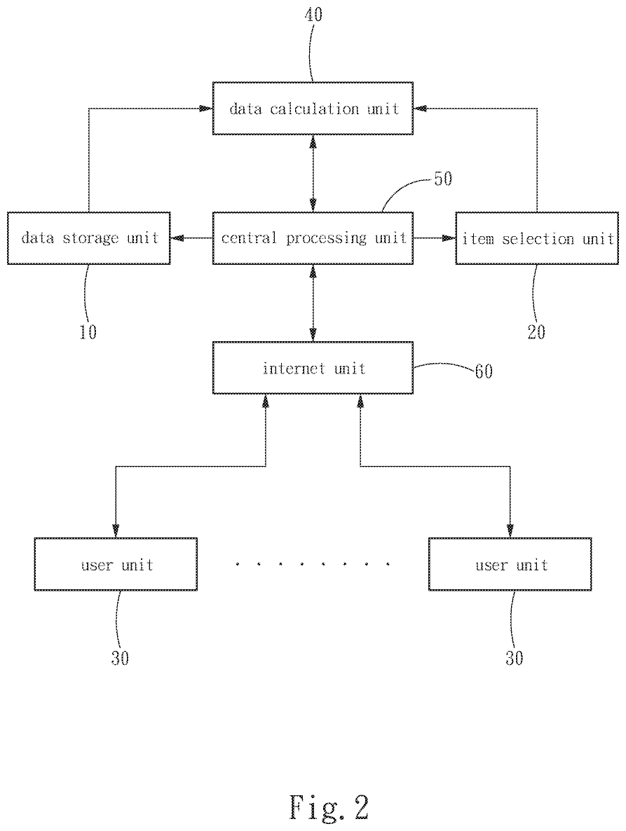

With reference to FIG. 2, the invention discloses a valuation system of game events in order to provide a contest game for a plurality of players to play, and the valuation system of game events includes a data storage unit 10, an item selection unit 20, a plurality of user units 30, a data calculation unit 40, and a central processing unit 50, wherein the data storage unit 10 acquires contest information of a substantial contest to be performed and contest data of the substantial contest after the substantial contest ends, the contest information containing a plurality of contest members participated in the substantial contest, the contest data including a plurality of item data of the plurality of contest members in a plurality of scoring items respectively. In an embodiment, the substantial contest is any one selected from ball games, races, athletics, water sports, outdoor sports, winter sports and fighting, and the plurality of scoring items are set according to the substantial contest. For example, if the substantial contest is basketball, the plurality of scoring items are scoring, shooting percentage, free throw percentage, three-point shooting percentage, rebounding, assists, steals, and blocks, etc.

The item selection unit 20 selects a specific quantity of the plurality of scoring items as a contest ranking item of the contest game. For example, three to six items of the plurality of scoring items can be selected as the contest ranking item. Taking basketball as an example, five items such as scoring, rebounding, assists, steals, and blocks, can be selected. While the item selection unit 20 generates the contest ranking item, in one embodiment, by any one of the plurality of players, the item selection unit 20 is manipulated through the user unit 30 to designate and select the specific quantity of the plurality of scoring items as the contest ranking item, and the other of the plurality of players may choose to continue participating in the contest game or choose to leave the contest game.

In another embodiment, the item selection unit 20 randomly selects a specific quantity of the plurality of scoring items as the contest ranking item, so that the contest ranking item of the contest game can be provided with considerable uncertainty by random selection by the system, thereby adding excitement to the contest game to increase the ability to attract players.

The plurality of user units 30 are respectively provided for the plurality of players to play and operate the contest game, and are respectively provided for registering, logging in, modifying and storing member data, and the plurality of user units 30 are respectively provided for the plurality of players to create a contest member list before the substantial contest is performed, and the contest member list is generated by selecting at least one from a plurality of contest members.

In an embodiment, each of the plurality of contest members is provided with a selection point, and a contest point is required to be paid when the plurality of players when creating the contest member list, the contest point is a sum of selection points of all the contest members in the contest member list. To be more specific, the plurality of players need to obtain game points in excess of the contest points in advance to pay the contest points when the contest member list is created.

The data calculation unit 40 calculates each of the plurality of item data of the contest ranking item according to a calculation rule, so as to obtain a valuation score. The data calculation unit 40 counts valuation scores of all contest members in each contest member list on the contest ranking item after the substantial contest ends, thereby generating a total score of all contest members in each contest member list, and ranks according to a magnitude of the total score to generate a contest ranking. In order to increase game excitement, the data calculation unit 40 generates a contest award point according to a sum of the contest points respectively paid by the plurality of players, and the data calculation unit 40 allocates the contest award point to the plurality of players according to the contest ranking. In other words, if a player ranked much higher in the contest ranking, a higher percentage of the contest award points may be earned.

The central processing unit 50 links and processes operations of the data storage unit 10, the item selection unit 20, the plurality of user units 30 and the data calculation unit 40 to perform transmission and exchange of the contest information, the contest data, the contest ranking item, the valuation score, the member data, the contest member list and the contest ranking. The central processing unit 50 is set to execute programs as follows: acquiring the contest information and creating the contest game; waiting for the plurality of players to join the contest game; waiting for the item selection unit 20 to create the contest ranking item; waiting for the plurality of players to create the contest member list; waiting for the substantial contest to start until ending; acquiring the contest data; and acquiring the contest ranking through the data calculation unit 40. In one embodiment, the central processing unit 50 wirelessly links the plurality of user units 30 via an Internet unit 60, and the plurality of user units 30 are any one selected from smart phones, tablet computers, notebook computers, personal computers and personal digital assistants.

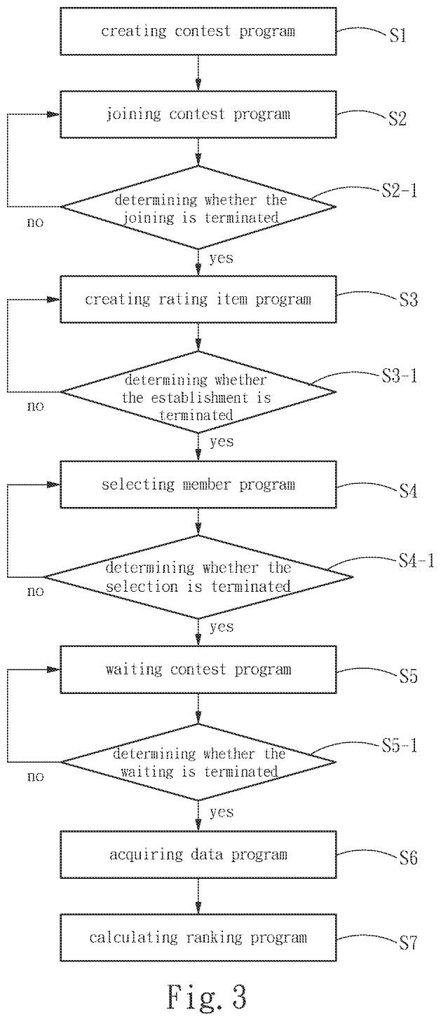

Referring again to FIG. 3, the present invention discloses a valuation method of the valuation system, wherein a program of the valuation method includes a creating contest program S1, a joining contest program S2, a creating rating item program S3, a selecting member program S4, a waiting contest program S5, an acquiring data program S6 and a calculating ranking program S7.

In the creating contest program S1, the central processing unit 50 acquires the contest information of the substantial contest through the data storage unit 10 so as to create the contest game.

In the joining contest program S2, the central processing unit 50 waits for the plurality of players to choose to join the contest game through the plurality of user units 30 for playing. In one embodiment, the method further includes a program S2-1 for determining whether the joining is terminated. In the program S2-1 for determining whether the joining is terminated, the central processing unit 50 determines whether the plurality of players joining the contest game reach a member quantity to start the contest game. If so, after a specified time, the central processing unit 50 terminates the joining contest program S2 and executes the creating rating item program S3; if not, the joining contest program S2 continues to be executed.

In the creating rating item program S3, the central processing unit 50 waits for the item selection unit 20 to select a specific quantity of the plurality of scoring items as the contest ranking item. In an embodiment, by any one of the plurality of players, the item selection unit 20 is manipulated via the plurality of user units 30 to designate and select a specific quantity of the plurality of scoring items as the contest ranking item. In another embodiment, the plurality of user units 30 randomly selects a specific quantity of the plurality of scoring items as the contest ranking item. In one embodiment, the method further includes a program S3-1 for determining whether the establishment is terminated. In the program S3-1 for determining whether the establishment is terminated, the central processing unit 50 determines whether the contest ranking item has been generated. If so, the central processing unit 50 terminates the creating rating item program S3 and executes the selecting member program S4; if not, the creating rating item program S3 continues to be executed.

In the selecting member program S4, the central processing unit 50 provides a selection time for the plurality of players to create the contest member list through the plurality of user units 30 before the substantial contest starts. The plurality of players selects at least one from the plurality of contest members to create the contest member list according to a selection rule. In an embodiment, the selection rule may not limit role characters played by the plurality of contest members in the substantial contest, i.e. the role characters played by the plurality of contest members in the substantial contest are not included in the selection rule. Alternatively, when there is a plurality of the contest member lists, the selection rule allows different contest members play the same role character in the substantial contest, i.e. the plurality of contest members selected by the plurality of players may play the same role character. In one embodiment, the method further includes a program S4-1 for determining whether the selection is terminated. In the program S4-1 for determining whether the selection is terminated, the central processing unit 50 determines whether the contest member list has been generated. If so, the central processing unit 50 terminates the selecting member program S4 and executes the waiting contest program S5; if not, the selecting member program S4 continues to be executed.

In the waiting contest program S5, the central processing unit 50 waits for the substantial contest to start until ending. In one embodiment, the method further includes a program S5-1 for determining whether the waiting is terminated. In the program S5-1 for determining whether the waiting is terminated, the central processing unit 50 determines whether the substantial contest has ended. If so, the central processing unit 50 terminates the waiting-contest program S5 and executes the acquiring data program S6; if not, the execution of the waiting contest program S5 is continued.

In the acquiring data program S6, the central processing unit 50 acquires the contest data through the data storage unit 10 after the substantial contest ends.

In the calculating ranking program S7, the central processing unit 50 firstly obtains the valuation score through the data calculation unit 40 and then generates the total score through the data calculation unit 40 and acquires the contest ranking.

In summary, the advantages of the present invention include at least:

1. The scoring items of the contest ranking item are created through the item selection unit, which may be created by the plurality of player selections or generated by the system automatically and randomly, which may increase the variability of the contest game so that the contest game maintains the ability to attract players.

2. The scoring items of the contest ranking item may vary and have sufficient variability. When the plurality of players create the contest member list according to the selection rule, the selection rule may not limit the role characters played by the plurality of contest members in the substantial contest, or the selection rule may allow different contest members to choose and play the same role character in the substantial contest at the same time to increase the freedom of the plurality of players to play.

What is claimed is:

1. A valuation system of game events, providing a contest game for a plurality of players to play, the valuation system of game events comprising:
a data storage unit configured to acquire a contest information of a substantial contest to be performed and contest data of the substantial contest after the substantial contest ends, the contest information containing a plurality of contest members engaged in the substantial contest, the contest data comprising a plurality of item data of the plurality of contest members in a plurality of scoring items respectively;
an item selection unit configured to select a specific quantity of the scoring items as a contest ranking item of the contest game;
a plurality of user units configured to be respectively provided for the plurality of players to play and operate the contest game, and be respectively provided for registering, logging in, modifying and storing member data, and the plurality of user units being respectively provided for the plurality of players to create a contest member before the substantial contest is performed, and a contest member list is generated by selecting at least one from a plurality of contest members;
a data calculation unit configured to calculate each of the plurality of item data of the contest ranking item according to a calculation rule, so as to obtain a valuation score, and the data calculation unit configured to count valuation scores of all contest members in each contest member list on the contest ranking item after the substantial contest ends, thereby generating a total score of each contest member list, and ranking according to a magnitude of the total score to generate a contest ranking; and
a central processing unit connected to the data storage unit, the item selection unit, the plurality of user units and the data calculation unit, the central processing unit configured to process operations of the data storage unit, the item selection unit, the plurality of user units and the data calculation unit to perform transmission and exchange of the contest information, the contest data, the contest ranking item, the valuation score, the member data, the contest member list and the contest ranking, and the central processing unit being configured to execute the following programs of:
acquiring the contest information and creating the contest game;
waiting for the plurality of players to join the contest game;
waiting for the item selection unit to create the contest ranking item;
waiting for the plurality of players to create the contest member list;
waiting for the substantial contest to start until ending;
acquiring the contest data; and
acquiring the contest ranking through the data calculation unit.

2. The valuation system of game events according to claim 1, wherein each of the plurality of contest members is provided with a selection point, and a contest point is required to be paid when the plurality of players create the contest member list, the contest point is a sum of selection points of all contest members in the contest member list.

3. The valuation system of game events according to claim 2, wherein the data calculation unit generates a contest award point according to a sum of contest points respectively paid by the plurality of players, and the data calculation unit allocates the contest award point to the plurality of players according to the contest ranking.

4. The valuation system of game events according to claim 1, wherein the substantial contest is any one selected from ball games, races, athletics, water sports, outdoor sports, winter sports and fighting.

5. The valuation system of game events according to claim 1, wherein by any one of the plurality of players, the item selection unit is manipulated via the user unit to designate and select a specific quantity of the plurality of scoring items as the contest ranking item.

6. The valuation system of game events according to claim 1, wherein the item selection unit randomly selects a specific quantity of the plurality of scoring items as the contest ranking item.

7. The valuation system of game events according to claim 1, wherein the central processing unit wirelessly links the plurality of user units via an internet unit.

8. The valuation system of game events according to claim 7, wherein the plurality of user units are any one selected from smart phones, tablet computers, notebook computers, personal computers and personal digital assistants.

9. A valuation method performed by the valuation system according to claim 1, the valuation method comprising:
a creating contest program S1, acquiring the contest information of the substantial contest through the data storage unit so as to create the contest game;
a joining contest program S2, waiting for the plurality of players to choose to join the contest game through the plurality of user units;
a creating rating item program S3, waiting for the item selection unit to select a specific quantity of the plurality of scoring items as the contest ranking item;
a selecting member program S4, providing a selection time for the plurality of players to create the contest member list through the plurality of user units before the substantial contest starts;
a waiting contest program S5, waiting for the substantial contest to start until ending by the central process unit;
an acquiring data program S6, acquiring the contest data through the data storage unit by the central process unit after the substantial contest ends; and
a calculating ranking program S7, obtaining the valuation score through the data calculation unit, and then generates the total score through the data calculation unit and acquires the contest ranking.

10. The valuation method according to claim 9, wherein each of the plurality of contest members is provided with a selection point, and a contest point is required to be paid when the plurality of players creating the contest member list, the contest point is a sum of selection points of the all contest members in the contest member list.

11. The valuation method according to claim 10, wherein the data calculation unit generates a contest award point according to a sum of the contest points respectively paid by the plurality of players, and the data calculation unit allocates the contest award point to the plurality of players according to the contest ranking.

12. The valuation method according to claim 9, wherein the substantial contest is any one selected from ball games, races, athletics, water sports, outdoor sports, winter sports and fighting.

13. The valuation method according to claim 9, wherein in the creating rating item program S3, by any one of the plurality of players, the item selection unit is manipulated via the plurality of user units to designate and select a specific quantity of the performance items as the contest ranking item.

14. The valuation method according to claim 9, wherein in the creating rating item program S3, the plurality of user units randomly selects a specific quantity of the plurality of scoring items as the contest ranking item.

15. The valuation method according to claim 9, wherein in the selecting member program S4, the plurality of players select at least one from the plurality of contest members according to a selection rule to create the contest member list.

16. The valuation method according to claim 15, wherein the selection rule is not limited to a role character played by the plurality of contest members in the substantial contest.

17. The valuation method according to claim 15, wherein when the contest member list is provided with more than one, the selection rule allows different contest members play a same role character in the substantial contest.
